(19) United States
(12) Patent Application Publication
(10) Pub. No.: US 2013/0252635 A1
(43) Pub. Date: Sep. 26, 2013

(54) METHOD AND APPARATUS FOR IDENTIFYING MOBILE STATIONS ASSOCIATED WITH A GEOGRAPHICAL AREA

(71) Applicants: Wen-Xue Zheng, Chengdu (CN); Guo-Zhu Lu, Chengdu (CN)

(72) Inventors: Wen-Xue Zheng, Chengdu (CN); Guo-Zhu Lu, Chengdu (CN)

(73) Assignee: MOTOROLA MOBILITY LLC, LIBERTYVILLE, IL (US)

(21) Appl. No.: 13/879,032

(22) PCT Filed: Nov. 2, 2010
(86) PCT No.: PCT/CN10/78332

§ 371 Date: Jun. 3, 2013

(51) Int. Cl. H04W 4/02

(52) U.S. Cl. CPC H04W 4/023
USPC 455/456.2

(57) ABSTRACT

A method and apparatus for identifying mobile stations within a target area is disclosed herein. The method includes receiving a request to identify mobile stations associated with a target area from a location-based application client. In response to receiving the request, a service node associated with the target area is identified and a request for a list of mobile stations associated with the target area is sent to the service node. The list of mobile stations received from the service node is then identified to the location-based application client.

### FIELD OF THE DISCLOSURE

The present invention relates generally to wireless communication systems and, more specifically, to identifying mobile stations within a geographical area within a wireless communication system.

### BACKGROUND

Increasingly, wireless operators are seeking to develop technology to support location-based services that target a specific user group. For example, it is preferable to send a short message containing a promotional coupon to only those mobile stations which are near the theater or restaurant offering the promotion. Some other location-based services require a list of all mobile stations in a specific area in order to push information relating to emergent evacuation, advertisement, etc., for specific areas. According to existing solutions, when a wireless communication system requires that mobile stations, in a particular geographical area, be informed of an emergency alert, advertisement, news, etc., the wireless communication system has to sequentially locate each of the mobile stations individually and select those mobile stations which are located within the geographical area of interest. However, this approach is inefficient and has a heavy impact on a wireless operator's network, for example, increased traffic between location server and core/radio network. Also, this approach may not be appropriate if an important message has to be received expediently by all of the mobile stations, for example, in an emergency situation.

Further, the location procedures defined in 3GPP (Third Generation Partnership Project) TS (Technical Specification) 23.271 etc., use a mobile identity-based method to locate mobile stations. The method involves a location server taking a mobile station's number as input and querying the core and radio network to get the mobile station's current Cell Identity (Cell ID) and other positioning parameters in order to map the mobile station to a location. However, current 3GPP standards lack interfaces to get a mobile station list when the input is a given area.

Accordingly, there is a need for a method and apparatus for creating a list of mobile stations within a geographical area.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating a wireless communication system in accordance with some embodiments.

FIG. 2 is a message flow diagram of a method for identifying mobile stations associated with a geographical area.

FIG. 3 is a block diagram of a location services node in accordance with some embodiments.

FIG. 4 is a flow chart illustrating a method of for identifying mobile stations associated with a geographical area.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally, a method, location services node, and system are disclosed for identifying mobile stations within a target area of a wireless communication network. In various embodiments of the invention, a method and location services node are disclosed that receive a request to identify mobile stations associated with a target area from a location-based application client. In response to receiving the request, the location services node translates the target area into a location area based on a identifier of the target area. Further, a service node associated with the target area is identified. Based on the service node identification, a request for a list of mobile stations associated with the target area is sent to the service node. The list of mobile stations received from the service node then is identified to the location-based application client. When the target area covers more than one service node, and hence each involved service node will have a corresponding request sent to, and the multiple lists of mobile stations received from the service nodes will be combined to one list by the location services node and then is sent to the location-based application client. While the description below may describe a system and method where only one service node is involved, this is done merely for the purpose of illustrating, and assisting the reader in understanding, the principles of the present invention and one of ordinary skill in the realizes that the present invention also covers cases involving multiple service nodes.

In other embodiments of the invention, a system is disclosed that includes a location services node in communication with a service node. The location services node receives, from a location-based application client, a request to identify mobile stations associated with the target area. The location services node maps the target area into a location area identifier, such as a Location Area Code, a Cell ID, or any other identifier of a location area in a wireless network as known in the art, and further identifies an a service node associated with the location area and sends a request for a list of mobile stations associated with the location area identifier to the service node. The service node conveys the list of mobile stations to the location services node and the location services node identifies the mobile stations included in the list to the location-based application client.

Before describing in detail the method for identifying mobile stations associated with a geographical area, it should be observed that the present invention resides primarily in combinations of method steps and apparatus components related to identifying mobile stations associated with a geographical area. Accordingly, the method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

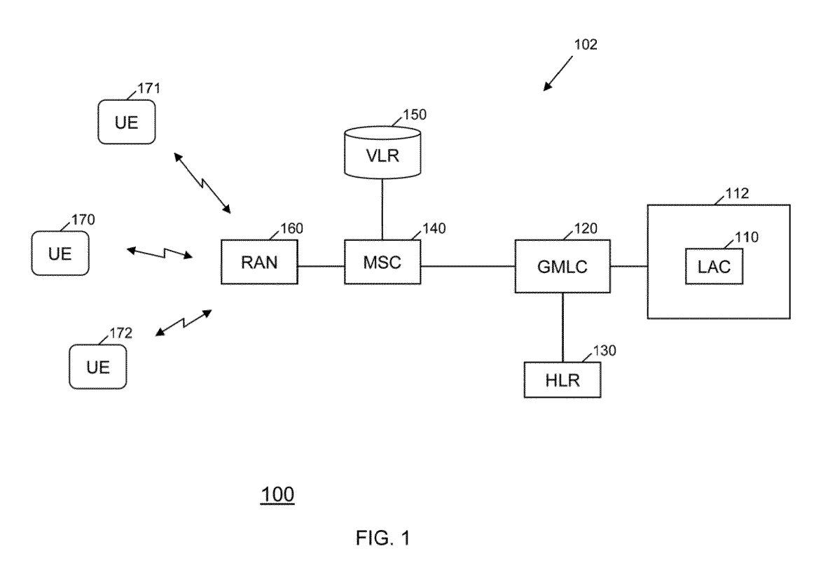

FIG. 1 is a block diagram illustrating a wireless communication system 100 for identifying mobiles stations associated within a geographical area. The wireless communication system 100 includes a Gateway Mobile Location Center (GMLC) 120 that is communicatively coupled to each of a Mobile Switching Center (MSC) 140, a Home Location Register (HLR) 130, and a server 112 that implements a location-based application client (LAC) 110. MSC 140 is, in turn, communicatively coupled to each of a Radio Access Network (RAN) 160 and a Visitor Location Register (VLR) 150. RAN 160 comprises one or more base transceiver stations (BTSs) and one or more base station controllers (BSCs) (not shown) and provides wireless communication services to one or more mobile stations 170-172 (three shown) that reside in a coverage area of the RAN. Server 112, GMLC 120, HLR 130, MSC 140, VLR 150, and RAN 160 may be collectively referred to as an infrastructure, or network, 102 of communication system 100 and each may be referred to herein as a network element of the communication system. The communication network 102 comprises any appropriate network, such as a wired network and/or a wireless network.

The communication system 100 may be any type of communication system capable of implementing location-based services. For example, communication system 100 may be a Global System for Mobile Communications (GSM) system, a Universal Mobile Telecommunications System (UMTS) system, a Code Division Multiple Access (CDMA) network, a CDMA-2000 system, an Integrated Digital Enhanced Network (iDEN) system, a Worldwide Interoperability for Microwave Access (WiMAX) system, or a combination thereof. Examples of the mobile station 170 include a mobile phone, a smartphone, a wireless communication-enabled personal digital assistant (PDA), a wireless communication-enabled laptop computer, or any other electronic device or wireless device having the ability to send and/or receive wireless communication information.

The GMLC 120 provides gateway functionality and enables a connection of the elements of network 102 to any external client. The GMLC 120 further functions as a location services node by providing location services as described herein in support of location-based applications. The GMLC 120 receives service requests from an external client, such as a location mapping software application or a mobile station (network-supported positioning) and activates a location services system, if needed. Furthermore, in case of a multi-technology network environment, for example, a network that implements both GSM and UMTS technologies, one common GMLC 120 may be used in association with both technologies.

The MSC 140 is a core network element, which controls the network switching subsystem elements. The MSC 140 also is the primary service delivery node for a GSM network, responsible for routing voice calls as well as other services and responsible for providing telecommunication services to one or more mobile stations within the geographical area served by the MSC 140 and also may be referred to herein as a service delivery node or merely service node. Such services include providing the signaling required for call set-up, routing, control and termination operations.

To gain access to GSM services, such as speech, data, and short message service (SMS), a mobile station, such as mobile stations 170-172, first registers with the network 102 to indicate the mobile station's current location by performing a location update and an International Mobile Subscriber Identity (IMSI) attach procedure. The mobile station also sends a location update including the mobile station's current location information to the MSC/VLR 140, 150, via RAN 160.

The HLR 130 is a centralized subscriber database for users to register to the wireless network 102. The HLR 130 stores static information about subscribers such as a subscriber's IMSI, subscribed services, and a key for authenticating the subscriber. As used herein, a subscriber refers to a mobile station, such as mobile stations 170-172, or a user of the mobile station, which subscriber has a service subscription with a network service provider associated with the HLR 130. The HLR 130 also stores dynamic subscriber information such as a current location of the mobile subscriber. The VLR 150 is a subscriber database that contains selected administrative information from the HLR 130 and contains information necessary for call control and provision of subscribed services for each mobile station currently located in a geographical area associated with the VLR 150. For example, the VLR 150 stores dynamic information such as the IMSI, authentication data, and telephone number of a roaming mobile station. The VLR 150 sends the subscriber's information to the HLR 130 where the subscriber's information is stored with the subscriber's dynamic records for use in call routing.

The HLR 130 and the VLR 150, together with the MSC 140, provide call routing and roaming capabilities in the communication system 100. As mentioned earlier, a mobile station, such as mobile stations 170-172, sends a location update including the mobile station's current location information to the MSCNLR 140, 150, via RAN 160. The location information then is sent to HLR 130. The HLR 130 then updates location information maintained in association with the mobile station with the location information received from the MSCNLR 140, 150. A location update also is performed when the mobile station moves to a new location area. Typically, a location update is periodically performed to update the HLR 130 as location updating events occur.

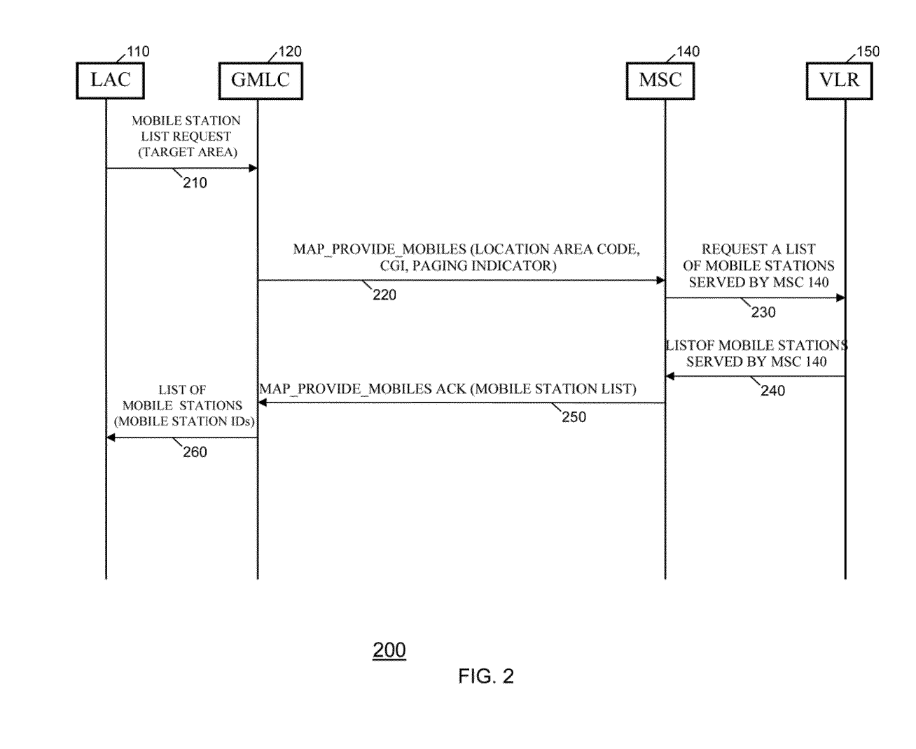

Referring now to FIG. 2, a message flow diagram 200 is provided that depicts a method of determining a position of a mobile station 170-172 within the wireless communication system 100 is described in accordance with an embodiment of the present invention. Initially, an LAC, that is, LAC 110, sends (210) to the GMLC 120 a request for a list of mobile stations within an identified geographical target area, as is described in greater detail below. The request also specifies a set of service-related parameters, including a requisite degree of accuracy, response time, preferred/required positioning method, and so on. In response to receiving the request, the GMLC 120 authenticates the LAC 110, for example, by checking an identifier (such as a name), an address (such as an Internet Protocol (IP) address), and/or a password associated with the LAC, against a LAC database maintained by the GMLC and by confirming, based on information maintained in the LAC database, that the LAC 110 is a subscriber to location-based service provided by communication system 100. Preferably, the LAC database is populated with such information by an operator of communication system 100 upon installation of the LAC. Upon proper authentication, the GMLC 120 identifies a location area associated with the identified geographical target area by mapping the target area to a location area identifier. The GMLC 120 further maps the target area to a service node identifier (preferably, an MSC identifier) associated with a service node that serves the location area. For example, the GMLC 120 may determine the location area identifier by translating the target area identified in the request to a corresponding location area identifier by reference to a list maintained, in an at least one memory device of the GMLC, of location area identifiers, such as a Location Area Code or a Cell Identifier (Cell ID), and corresponding geographical areas. In addition, the GMLC 120 maintains, in the at least one memory device of the GMLC, a list of location area identifiers and corresponding MSC identifiers, such as an MSC number (an ISDN number that serves as an address of the MSC in a wireless network), serving the location area.

Upon determining the address/number of the serving MSC, the GMLC 120 sends (220) a message to the serving MSC, that is, MSC 140, requesting a list of mobile stations within the identified location area. The message also may include service-related parameters specified by the LAC 110. Upon receiving the message from GMLC 120, the serving MSC 140 conveys (230) a message to MSC 140's associated VLR, that is, VLR 150, requesting that the VLR generate a list of mobile stations currently located within the location area being served by the MSC 140. The VLR 150 maintains subscriber data for mobile stations currently located in the location area being controlled by the VLR 150. The message conveyed by the GMLC 120 to the MSC 140 also may contain a paging indicator. When the paging indicator is set, the MSC will convey a paging message to the corresponding location area, and in particular to RAN(s) serving the location area, instructing the RAN(s) to page mobile stations served by the RAN(s) in order to obtain updated locations of those mobile stations either in dedicated or idle mode. In any event, the VLR 150 maintains dynamic records of those mobile stations currently located in the location area served by the MSC 140 and generates, and conveys (240) back to the serving MSC 140, a list of such mobile stations. For example, the MSC 140 may provide the list of mobile stations in a MAP_PROVIDE_MOBILES ACK message, where the list includes a list of mobile station identifiers identifying the mobile stations within the location area. Examples of a mobile station identifier include an IMSI, a TMSI, a telephone number, and so on.

The serving MSC 140 then conveys (250) the received list of mobile stations that are currently located within the identified location area to the GMLC 120. In turn, the GMLC 120 sends (260) the list of mobile stations to the location-based application client 110.

For example, and provided merely for the purpose of illustrating the principles of the present invention, suppose a location-based application client such as an advertising agency desires to send a promotional coupon to a target group of users. The coupon can be used to avail a discount on purchase(s) made at a particular store offering such discounts. In this example, the coupon can be received by the target group of users in the form of a short message (SMS), a Multimedia message (MMS), or a call on their cellular phones. The target users are typically cellular phone users who are proximate to the store and possess and/or carry their cellular phone along with them. For example, the users can be residents or visitors within a specific geographic area relative to the location of the store. The specific geographic area can be defined in terms of a geographic radius, for example, within a 5 kilometer radius around the store. In another example, the geographic radius can be specified as geographic regions defined by a name or an address.

In order to provide the coupon to the target group of users, the advertising agency may require a list of cellular phones currently located within the 5 kilometer radius from the store. In accordance with some embodiments of the invention, the advertising agency sends a request for a list of cellular phones that are currently located within the target area (within 5 km radius) to a location services node, such as GMLC 120. The location services node translates the target area information into location area information, i.e., the geographic area defined by the 5 km radius is translated to a Location Area Code, a Cell ID, or any such location area identifier. The location services node then looks up its internal data base to get the service node serving that location area. The location services node sends a request for a list of cellular phones located within the location area to the service node. The service node generates the list of cellular phones that are currently located within the specified location area and provides the list to the location services node. The list includes cellular phone numbers or any other such identifiers for identifying the cellular phones. The location services node in turn provides the cellular phone list to the advertising agency. Using the cellular phone identifiers included in the list, the advertising agency then may send the coupon, for example, as an SMS message, to each of the listed cellular phones. The coupon is thus provided to only those cellular phones (users) residing in or visiting the target area.

Thus, communication system 100 is configured to identify mobile stations within a target area. The target area refers to a geographical area of interest to a location-based application client. The system includes a location services node operated to receive a request to identify mobile stations associated with the target area from a location-based application client, such as LAC 110. The request to identify mobile stations associated with the target area includes an identifier of the target area. In an example, the location services node is a GMLC, such as GMLC 120. Examples of the location-based application client 110 include a mobile marketing system, a public safety system, an advertising agency, etc.

Prior to sending the query to the service node, the location services node translates the received target area into a location area that is identifiable by the service node. For example, the location-based application client may specify the target area identity in terms of geographical parameters (latitude/longitude values), including a name of a region, a landmark, coordinate values, a territory identifier, a physical map area, a political map area, etc. The location services node translates the specified target area into location area information, such as a Location Area Code, a Cell ID, etc., and includes the location area information in the query sent to the service node.

The location services node maintains two associations, one between target areas and corresponding location areas and another between location areas and corresponding service nodes within the wireless communication network. In response to receiving the query, the location services node maps the target area into a location area and further identifies the service node associated with the location area. The service node identification can be, for example, an MSC number. The location services node sends a request for a list of mobile stations associated with the location area to the service node. The service node then generates a list of mobile devices located within the location area and provides the list to the location services node.

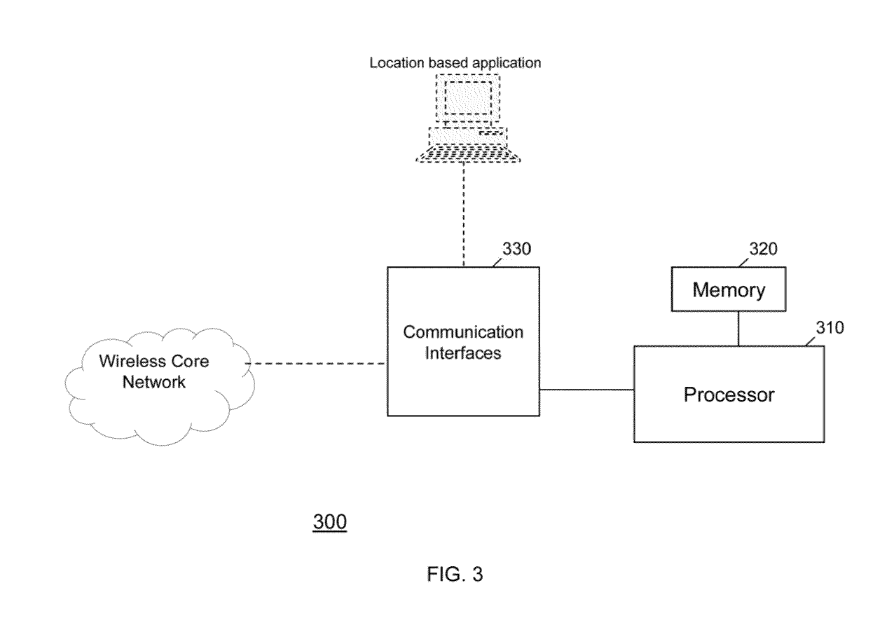

FIG. 3 is a block diagram of a location services node 300, such as GMLC 120, in accordance with various embodiments of the present invention. The location services node 300 includes a processor 310, such as one or more microprocessors, microcontrollers, digital signal processors (DSPs), combinations thereof or such other devices known to those having ordinary skill in the art. The location services node 300 further includes an at least one memory device 320 associated with the processor, such as random access memory (RAM), dynamic random access memory (DRAM), and/or read only memory (ROM) or equivalents thereof, that store data and programs that may be executed by the processor and allow the locations services node to operate in communication system 100 and perform the functionality described herein. The at least one memory device 320 further maintains the lists described herein of target areas and corresponding location areas and location areas and corresponding service nodes within the wireless communication network. In addition, the location services node 300 includes a communication interface 330 coupled to the processor 310. The location services node 300 may further optionally include (not shown) a video adapter to provide connectivity to a local display and an I/O adapter unit to provide an input/output interface for one or more input/output devices, such as a mouse, a keyboard, printer, tape drive, CD drive, or the like.

The communication interface 330 may include a wired link, such as an Ethernet cable or the like, and/or a wireless/cellular link, that provides a connection to the wireless core network and a location-based application client, such as LAC 110. In an embodiment, the communication interface 330 may comprise a switching fabric for switching bearer and signaling channels. The communication interface 330 also may comprise a suitable receiver and transmitter for performing wireless communications. It should be noted that the location services node 300 may include other components. For example, the location services node 300 may include power supplies, cables, a motherboard, removable storage media, cases, and the like. These other components, although not shown, are considered part of the location services node 300.

The processor 310 is configured to receive a request for identifying mobile stations associated with a target area from the location-based application client 110. The request includes a target area identifier identifying a geographical area of interest to the location-based application. In response to the received request, the processor 310 translates the target area identifier to a location area identifier based on an association between the target area identifier and a location area identifier. The association between the target area identifier and a location area identifier is maintained in the at least one memory device 320 and accessed by the processor 310. The processor 310 further identifies the serving service node based on an association between the location area identifier and a service node identifier maintained in the at least one memory device 320. Based on the received identification, the processor 310 conveys a request for a list of mobile stations associated with the target area to the identified service node. In response to conveying the request, the processor 310 receives the requested list of mobile stations from the service node and identifies the mobile stations in the list to the location-based application client 110.

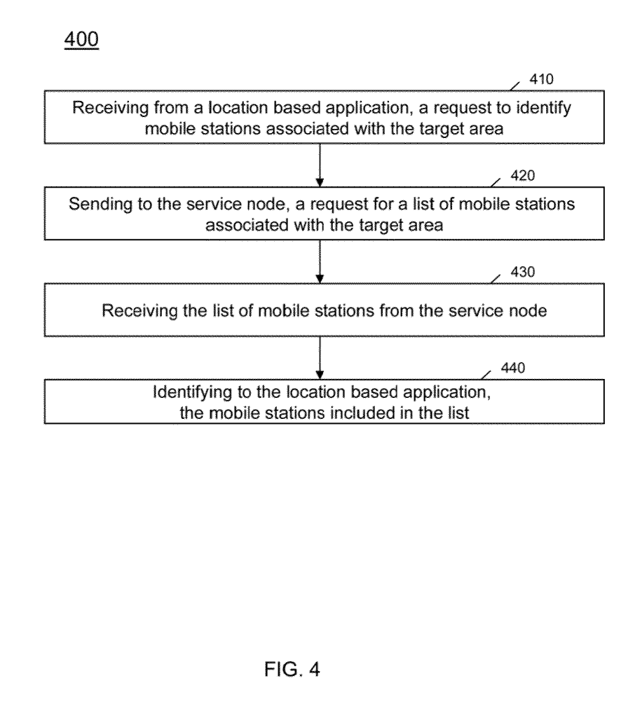

FIG. 4 is a logic flow diagram 400 illustrating a method 400 of for identifying mobile stations associated with a geographical area in accordance with an embodiment of the present invention. Logic flow diagram 400 begins with a location services node, such as GMLC 120, receiving (410), from a location-based application client such as LAC 110, a request to identify mobile stations associated with the geographical area, also referred to as a ‘target’ area. The request to identify mobile stations associated with the target area includes an identifier of the target area. Examples of a target area identifier include a name of a region, a landmark, coordinate values, a territory identifier, a physical map area, a political map area, etc. In response to receiving the request, the location services node translates the target area into location area and further identifies a corresponding serving services node. For example, the location area identifier can be a Location Area Code or a Cell Identity, and a service node identification can be, for example, a MSC number.

The location services node then sends to the identified service node, and the service node receives (420) from the location services node, the request to identify mobile stations associated with the target area. In response to receiving the request, the service node generates a list of mobile stations located in the target area, for example, mobile stations 170-172, and conveys the list to the location services node. The location services node receives (430) the list of mobile stations from the service node and identifies (440) the mobile stations included in the list to the location-based application client. The list of mobile stations includes mobile station identifiers associated with mobile stations currently located in the target area. The list of mobile stations may be received from the service node in a MAP_PROVIDE_MOBILES ACK message, the message having mobile station identifiers. Logic flow diagram 400 then ends.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method in a wireless communication network for identifying mobile stations within a target area, the method comprising:
receiving, from a location-based application client, a request to identify mobile stations associated with the target area;
identifying a service node associated with the target area;
based on the received identification, sending, to the service node, a request for a list of mobile stations associated with the target area;
receiving the list of mobile stations from the service node; and
identifying, to the location-based application client, the mobile stations included in the list.

2. The method of claim 1, wherein receiving a request to identify mobile stations associated with a target area comprises receiving a request for a list of mobile stations located within the target area.

3. The method of claim 1, wherein the request to identify mobile stations associated with the target area comprises an identifier of the target area.

4. The method of claim 3, further wherein, in response to receiving the request to identify mobile stations associated with the target area, translating the target area identifier into a location area identifier.

5. The method of claim 4, wherein translating the target area identifier into a location area identifier comprises translating the target area identifier into at least one of a Location Area Code and a Cell Identity.

6. The method of claim 1, wherein identifying a service node associated with the target area comprises looking up an association between one or more location area identifiers and one or more service node numbers.

7. The method of claim 6, wherein sending a request to the service node for a list of mobile stations associated with the target area comprises sending the request using the service node number.

8. The method of claim 1, wherein sending the request to the service node comprises sending a MAP_PROVIDE_MOBILES message to the service node, the message comprising a location area identifier and a paging indicator.

9. The method of claim 1, wherein receiving the list of mobile stations from the service node comprises receiving a MAP_PROVIDE_MOBILES ACK message, the message comprising mobile station identifiers.

10. The method of claim 1, wherein the method is performed by a location services node.

11. The method of claim 1, further comprising receiving, by the service node, the request for a list of mobile stations associated with the target area and, in response to receiving the request for a list of mobile stations associated with the target area, conveying, by the service node, the list of mobile stations.

12. The method of claim 11, further wherein receiving the request for a list of mobile stations associated with the target area comprises receiving a MAP_PROVIDE_MOBILES message, wherein upon receiving the MAP_PROVIDE_MOBILES message, the service node conducts paging within the target area.

13. A location services node in a wireless communication network comprising:
a processor coupled to an interface to core networks, an interface to location-based application client and configured to:
receive from a location-based application client, a request to identify mobile stations associated with a target area,
identify a service node associated with the target area,
based on the received identification, send, to the service node, a request for a list of mobile stations associated with the target area,
receive the list of mobile stations from the service node, and
identify, to the location-based application client, the mobile stations included in the list.

14. The location services node of claim 13, wherein the request to identify mobile stations associated with a target area comprises an identifier of the target area and a paging indicator.

15. The location services node of claim 13, further comprising at least one memory device coupled to the processor that maintains an association between the target area identifier and a location area identifier.

16. The location services node of claim 13, further comprising at least one memory device coupled to the processor that maintains an association between the location area identifier and an identifier of a service node serving the target area.

17. A system in a wireless communication network for identifying mobile stations within a target area, the system comprising:
a location services node that is configured to receive a request to identify mobile stations associated with the target area from a location-based application client and to identify a service node associated with the target area and send a request for a list of mobile stations associated with the target area to the service node, and in response to receiving a list of mobile stations from the service node, identify the mobile stations included in the list to the location-based application client; and
the service node that is configured to receive the request for a list of mobile stations associated with the target area and, in response to receiving the request, convey the list of mobile stations to the location services node.

18. The system of claim 17, wherein the location services node is a Gateway Mobile Location Center (GMLC) and the service node is a Mobile Switching Center (MSC).

19. The system of claim 17, wherein the request to identify mobile stations associated with the target area comprises an identifier of the target area, wherein the location services node is further operated to translate the target area identifier into a location area identifier.

20. The location services node of claim 17, wherein the location services node is further operated to map the location area identifier against a service node identification.
